(19) United States
(12) Patent Application Publication
(10) Pub. No.: US 2005/0188682 A1
(43) Pub. Date: Sep. 1, 2005

(54) Method for accelerated heating of a cleaning device in the exhaust gas train of an internal combustion engine, and internal combustion engine

(76) Inventors: Peter Fledersbacher, Stuttgart (DE); Siegfried Weber, Stuttgart (DE)

Correspondence Address: WILLIAM COLLARD;COLLARD & ROE, P.C., 1077 NORTHERN BOULEVARD, ROSLYN, NY, 11576, US

(21) Appl. No.: 11/066,403

(22) Filed: Feb. 25, 2005

(30) Foreign Application Priority Data
Feb. 28, 2004 (DE) 10 2004 009 791.7

(51) Int. Cl. F01N 5/04; F02D 23/00

(52) U.S. Cl. 60/284; 60/280

(57) ABSTRACT

In a method for accelerated heating of a cleaning device in the exhaust gas train of an internal combustion engine, the temperature of the cleaning device is determined, and if the temperature lies below a reference value, a bypass is opened and a variable turbine geometry is closed.

### BACKGROUND OF THE INVENTION

1. Field of the Invention

The invention relates to a method for accelerated heating of a cleaning device in the exhaust gas train of an internal combustion engine, and to an internal combustion engine.

2. The Prior Art

A charged internal combustion engine having a compressor in the intake tract and an exhaust gas turbine in the exhaust gas train is described in German Patent No. DE 198 33 148 A1, whereby a catalytic converter is disposed downstream from the exhaust gas turbine, in the exhaust gas train, for converting and reducing harmful exhaust gas emissions. In order to heat the catalytic converter to its operating temperature in as short a time as possible after a cold start of the internal combustion engine, the exhaust gas turbine can be bridged by a bypass channel, so that the exhaust gas is passed directly to the catalytic converter, circumventing the turbine wheel, and heats it. The bypass channel can be opened and closed by way of a non-return valve, as a function of the operating state of the internal combustion engine. In this connection, the bypass channel takes on the function of a waste gate. With exhaust gas turbochargers, however, there is the risk that despite the waste gate being open, a significant proportion of the exhaust gas flows through the turbine and gives off heat in doing so, partly by means of cooling off on the walls of the exhaust gas turbine, and partly because of the expansion of the exhaust gas. This can have the result that despite the exhaust gas being blown off by the waste gate, heating of the catalytic converter to its operating temperature is delayed.

### SUMMARY OF THE INVENTION

It is therefore an object of the invention to heat a cleaning device in the exhaust gas train of an internal combustion engine to its operating temperature in as short a time as possible, after a cold start.

This object is achieved according to the invention, by a method for accelerated heating of a cleaning device in the exhaust gas train of an internal combustion engine, which is equipped with an exhaust gas turbocharger having a compressor in the intake tract and an exhaust gas turbine having a variable turbine geometry in the exhaust gas train, and a bypass for bridging the turbine wheel, having an adjustable bypass non-return valve, wherein the exhaust gas cleaning device is disposed downstream of the exhaust gas turbine, and the variable turbine geometry and the bypass non-return valve can be adjusted as a function of current status and operating variables of the internal combustion engine, the method comprising the following method steps:
determining the temperature T_{Kat} of the cleaning device or a value correlating to said temperature, and
closing the variable turbine geometry and opening the bypass non-return valve when the temperature (T_{Kat}) of the cleaning device or the value correlating to that temperature lies below a reference value (T_{B}).

With the method according to the invention, in addition to opening the bypass when the temperature of the cleaning device lies below a preference value such as the operating temperature, a variable turbine geometry is also brought into its blocked position, in which the effective turbine entry cross-section in the exhaust gas turbine is blocked off or at least reduced to a minimum. In other words, two measures are taken at the same time after a cold start of the internal combustion engine, which ensure rapid heating of the cleaning device. The bypass for circumventing the turbine wheel is opened, and the variable turbine geometry is closed, so that practically no or only a negligible proportion of exhaust gas can pass through the turbine, and practically the entire exhaust gas stream is passed directly to the exhaust gas cleaning device, by way of the bypass. Heat losses as the result of heat transfer to the turbine housing or as the result of expansion in the turbine can be avoided in this manner.

It can be practical to subject the settings for the bypass non-return valve and the variable turbine geometry that promote rapid heating of the exhaust gas cleaning device to a fixed, hierarchical order with regard to competitive settings that can occur in the case of other engine operating conditions. Thus, it is advantageous, particularly from the aspect of the lowest possible exhaust gas emissions, to put the variable turbine geometry into the blocked position when the temperature of the exhaust gas cleaning device is below its operating temperature, and to open the bypass, in order to give precedence to heating of the exhaust gas cleaning device even if there is a full-load demand, which would result in closing of the bypass and opening of the variable turbine geometry under normal operating conditions, i.e. when the operating temperature of the exhaust gas cleaning device has already been reached. Using such a precedence regulation in favor of rapid heating of the exhaust gas cleaning device, it is possible to further minimize the exhaust gas emissions.

However, alternative precedence regulations are also possible. For example, it is possible to grant a driver demand precedence, so that in the case of a full-load demand, the bypass and the variable turbine geometry are switched to a position that fulfills this demand, regardless of the temperature of the exhaust gas cleaning device.

The internal combustion engine is equipped with an exhaust gas turbocharger having a compressor in the intake tract and an exhaust gas turbine in the exhaust gas train. The exhaust gas turbine is provided with a variable turbine geometry for a changeable setting of the effective turbine entry cross-section. Furthermore, an exhaust gas cleaning device is provided downstream of the exhaust gas turbine in the exhaust gas train. Furthermore there is a bypass, such as a waste gate, which serves to bridge the turbine wheel and in which an adjustable bypass non-return valve is disposed. By way of a control and regulation device, setting signals for setting both the bypass non-return valve and the variable turbine geometry as a function of current status and operating variables of the internal combustion engine can be generated. Finally, a measurement device for determining the temperature of the cleaning device is provided. If the temperature of the cleaning device, or a value that correlates to it, goes below a reference value, the control and regulation device generates setting signals to change the variable turbine geometry over to its blocked position and, at the same time, the bypass non-return valve is changed over to its open position, so that the entire exhaust gas output of the internal combustion engine is passed directly to the cleaning device, circumventing the exhaust gas turbine.

Instead of measuring the temperature of the exhaust gas cleaning device, a value that correlates to it can also be determined, from which a conclusion can be drawn concerning the temperature of the exhaust gas cleaning device. The reference value is chosen accordingly.

### BRIEF DESCRIPTION OF THE DRAWINGS

Other objects and features of the present invention will become apparent from the following detailed description considered in connection with the accompanying drawings. It is to be understood, however, that the drawings are designed as an illustration only and not as a definition of the limits of the invention.

In the drawings, wherein similar reference characters denote similar elements throughout the several views:

FIG. 1 shows a schematic representation of a charged internal combustion engine, which has an exhaust gas cleaning device downstream from the exhaust gas turbine, whereby a bypass that bridges the exhaust gas turbine is provided with an adjustable non-return valve; and

FIG. 2 shows a flow chart for implementation of a method for accelerated heating of the exhaust gas cleaning device.

### DETAILED DESCRIPTION OF THE PREFERRED EMBODIMENT

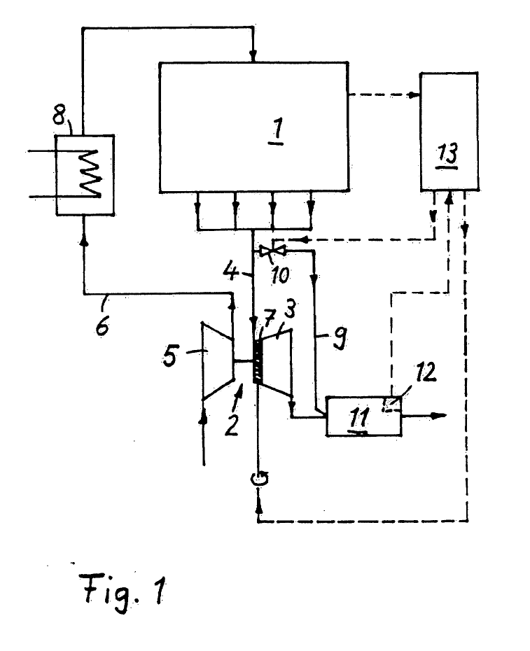

Referring now in detail to the drawings, FIG. 1 shows an internal combustion engine 1, which is a gasoline engine or diesel engine having an exhaust gas turbocharger 2 with an exhaust gas turbine 3 in the exhaust gas train 4 and a compressor 5 in the intake tract 6 of the internal combustion engine assigned to it. The turbine wheel of exhaust gas turbine 3 is driven by the exhaust gases of the internal combustion engine, which are under pressure, whereby the rotational movement of the turbine wheel is transferred, by way of a shaft, to the compressor wheel in compressor 5, which then compresses combustion air drawn in at ambient pressure to an elevated charging pressure. The compressed combustion air is cooled in a charging air cooler 8 disposed downstream of compressor 5, in an exhaust gas train 6, and subsequently passed to the cylinders of the internal combustion engine 1 under charging pressure.

On the exhaust gas side, an exhaust gas cleaning device 11 is disposed on the exhaust gas train downstream of exhaust gas turbine 3. Device 11 could be a catalytic converter or a filter device or a combination of a catalytic converter and a filter device.

Furthermore, a bypass 9 that bridges exhaust gas turbine 3 is provided, which branches off from exhaust gas train 4 upstream from exhaust gas turbine 3, and opens into exhaust gas train 4 again downstream from the exhaust gas turbine and directly upstream from catalytic converter 11. An adjustable bypass non-return valve 10 is disposed in bypass 9.

Exhaust gas turbine 3 is provided with a variable turbine geometry 7, which allows a changeable adjustment of the effective turbine entry cross-section. The variable turbine geometry 7 can be adjusted between a blocked position that reduces the turbine entry cross-section and an open position that maximally releases the turbine entry cross-section.

Variable turbine geometry 7 is configured, for example, as a guide grid having adjustable guide vanes, which is disposed in the turbine cross-section. As another exemplary embodiment, an axially displaceable guide grid would be possible.

Exhaust gas cleaning device 11 has a measurement device 12 for determining the current temperature of the exhaust gas cleaning device assigned to it.

Furthermore, internal combustion engine 1 is provided with a control and regulation device 13, which generates setting signals as a function of current status and operating variables of internal combustion engine 1 or of the units assigned to the internal combustion engine, which signals are to be passed to the adjustable units of the internal combustion engine, in order to set them to a desired value or into a desired position. As input variables, the current temperature of exhaust gas cleaning device 11 determined in measurement device 12, as well as the load and the speed of rotation of internal combustion engine 1 are taken into consideration, among other things. The setting signals generated by control and regulation device 13 are passed to variable turbine geometry 7 of exhaust gas turbine 3 and to bypass non-return valve 10, among other things.

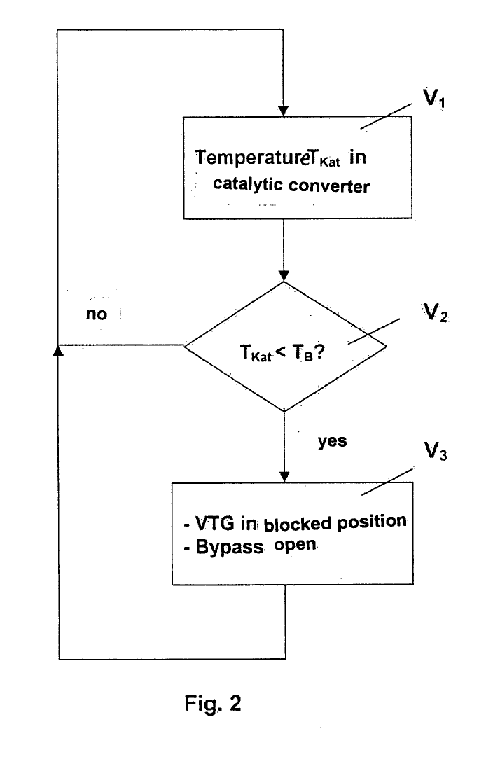

The flow chart shown in FIG. 2 illustrates the method for accelerated heating of the exhaust gas cleaning device after a cold start of the internal combustion engine. In a first method step V₁, the current temperature T_{Kat} in the catalytic converter, i.e. of the exhaust gas cleaning device, is first determined; as described above in connection with FIG. 1, this is done using measurement device 12 assigned to exhaust gas cleaning device 11.

In a subsequent method step V₂, the current catalytic converter temperature T_{Kat} is compared with the operating temperature T_{B} of the catalytic converter, whereby the operating temperature T_{B} represents the reference value that must be exceeded so that the catalytic converter reaches its full functionality. When the current catalytic converter temperature T_{Kat} is greater than or equal to the operating temperature T_{B}, the no branch leads back to the first method step V₁; in this case, the current catalytic converter temperature is at least as great as the operating temperature T_{B} of the catalytic converter, so that the catalytic converter has reached its full functionality.

If the current catalytic converter temperature T_{Kat} has not yet reached the operating temperature T_{B}, the yes branch leads to the subsequent method step V₃, according to which measures are taken to achieve the fastest possible heating of the catalytic converter. For this purpose, two measures are carried out: First, the variable turbine geometry (abbreviated as VTG; provided with the reference number 7 in FIG. 1) is moved to its blocked position, in which the effective turbine entry cross-section is reduced to a minimum and, if applicable, is actually completely blocked off. Second, the bypass 10 is opened, so that the exhaust gases located in the exhaust gas line train between internal combustion engine 1 and exhaust gas turbine 3 can flow off by way of bypass 9, circumventing the exhaust gas turbine, and are passed directly to the catalytic converter. Using these measures, it is possible to achieve the fastest possible heating of the exhaust gas cleaning device after a cold start of the internal combustion engine, without providing additional heating means.

The entire method shown in FIG. 1 is repeated at cyclical intervals; when the current catalytic converter temperature T_{Kat} no longer lies below the operating temperature T_{B}, the measures with regard to the variable turbine geometry and the bypass non-return valve can be cancelled. The variable turbine geometry as well as the bypass non-return valve can be set on the basis of other criteria after cancellation of these measures, particularly as a function of the engine load and the engine speed of rotation.

Accordingly, while only a few embodiments of the present invention have been shown and described, it is obvious that many changes and modifications may be made thereunto without departing from the spirit and scope of the invention.

1. A method for accelerated heating of a cleaning device in an exhaust gas train of an internal combustion engine equipped with an exhaust gas turbocharger having a compressor in the intake tract and an exhaust gas turbine having a variable turbine geometry in the exhaust gas train, and a bypass for bridging a turbine wheel, and having an adjustable bypass non-return valve, wherein the cleaning device is disposed downstream of the exhaust gas turbine, and the variable turbine geometry and the bypass non-return valve can be adjusted as a function of current status and operating variables of the internal combustion engine, the method comprising the following method steps:
determining the temperature T_{Kat} of the cleaning device or a value correlating to said temperature, and
closing the variable turbine geometry and opening the bypass non-return valve when the temperature (T_{Kat}) of the cleaning device or a value correlating to said temperature lies below a reference value (T_{B}).

2. The method according to claim 1, wherein at least one of the variable turbine geometry and bypass non-return valve remains in a starting position until the temperature (T_{Kat}) of the cleaning device or the value correlating to it reaches the reference value (T_{B}).

3. The method according to claim 2, wherein both the variable turbine geometry and the bypass non-return valve remain in starting positions until the temperature (T_{Kat}) of the cleaning device (11) or the value correlating to it reaches the reference value (T_{B}).

4. An internal combustion engine, comprising:
an exhaust gas turbocharger having a compressor in an intake tract and an exhaust gas turbine in an exhaust gas train;
a cleaning device in the exhaust gas train positioned downstream from the exhaust gas turbine;
a bypass for bridging a turbine wheel of the exhaust gas turbine, said bypass having an adjustable bypass non-return valve;
a measurement device for measuring the temperature (T_{Kat}) of the cleaning device or of a value correlating to the temperature of the cleaning device;
a control and regulation device for generating setting signals for setting the bypass non-return valve as a function of current status and operating variables of the internal combustion engine; and
a variable turbine geometry in the exhaust gas turbine, said geometry adapted to be adjusted by way of the setting signals of the control and regulation unit;
wherein the variable turbine geometry is changed over to a blocked position, and the bypass non-return valve is changed over to an open position when temperature (T_{Kat}) of the cleaning device or a value that correlates with it, lies below a reference value (T_{B}).
